(19) United States
(12) Patent Application Publication
(10) Pub. No.: US 2020/0248736 A1
(43) Pub. Date: Aug. 6, 2020

(54) OFF-ROAD VEHICLE SUSPENSION FASTENER

(71) Applicant: Robby Gordon, Charlotte, NC (US)

(72) Inventor: Robby Gordon, Charlotte, NC (US)

(21) Appl. No.: 16/779,424

(22) Filed: Jan. 31, 2020

Related U.S. Application Data
(60) Provisional application No. 62/801,272, filed on Feb. 5, 2019.

(51) Int. Cl. F16B 35/06; F16B 43/00; B60G 7/00

(52) U.S. Cl. CPC F16B 35/06; F16B 43/001; F16B 2200/50; B60G 2300/07; B60G 7/008

(57) ABSTRACT

An apparatus is provided for a fastener for off-road vehicle suspension systems. The fastener comprises a flanged bolt that includes a shank with a threaded portion at one end. A washer flange and a head are disposed at an end of the shank opposite of the threaded portion. The washer flange and the head comprise a single component. A flanged nut threadably engages with the threaded portion and includes a hex head and a washer flange. In an assembled state of the fastener, the flanged nut is fully engaged with the threaded portion, such that the shank extends between a finished surface comprising the flanged nut and a finished surface comprising the washer flange. The assembled state includes the finished surface of the flanged nut being parallel with the finished surface of the washer flange, such that a grip distance is disposed between the parallel finished surfaces.

### PRIORITY

This, application claims the benefit of and priority to U.S. Provisional Application, entitled “Off-Road Vehicle Suspension Fastener,” filed on Feb. 5, 2019 and having application Ser. No. 62/801,272, the entirety of said application being incorporated herein by reference.

### FIELD

Embodiments of the present disclosure generally relate to the field of vehicle suspension systems. More specifically, embodiments of the disclosure relate to a fastener for off-road vehicle suspension systems.

### BACKGROUND

A double wishbone suspension is a well-known independent suspension design using upper and lower wishbone-shaped arms to operably couple a front wheel of a vehicle. Typically, the upper and lower wishbones or suspension arms each has two mounting points to a chassis of the vehicle and one mounting joint at a spindle assembly or knuckle. A shock absorber and a coil spring may be mounted onto the wishbone to control vertical movement of the front wheel. The double wishbone suspension facilitates control of wheel motion throughout suspension travel, including controlling such parameters as camber angle, caster angle, toe pattern, roll center height, scrub radius, scuff, and the like.

Double wishbone suspensions may be used in a wide variety of vehicles, including heavy-duty vehicles, as well as many off-road vehicles, as shown in FIG. 1. FIG. 1 shows an off-road vehicle 100 that is of a Side by Side variety. The Side by Side is a four-wheel drive off-road vehicle that typically seats between two and six occupants, and is sometimes referred to as a Utility Task Vehicle (UTV), a Recreational Off-Highway Vehicle (ROV), or a Multipurpose Off-Highway Utility Vehicle (MOHUV). In addition to the side-by-side seating arrangement, many UTVs have seat belts and roll-over protection, and some may have a cargo box at the rear of the vehicle. A majority of UTVs come factory equipped with hard tops, windshields, and cab enclosures.

The double-wishbone suspension often is referred to as “double A-aims”, although the arms may be A-shaped, L-shaped, J-shaped, or even a single bar linkage. In some embodiments, the upper aim may be shorter than the lower arm so as to induce negative camber as the suspension jounces (rises). Preferably, during turning of the vehicle, body roll imparts positive camber gain to the lightly loaded inside wheel, while the heavily loaded outer wheel gains negative camber.

The spindle assembly, or knuckle, is coupled between the outboard ends of the upper and lower suspension arms. In some designs, the knuckle contains a kingpin that facilitates horizontal radial movement of the wheel, and rubber or trunnion bushings for vertical hinged movement of the wheel. In some relatively newer designs, a ball joint may be disposed at each outboard end to allow for vertical and radial movement of the wheel. A bearing hub, or a spindle to which wheel bearings may be mounted, may be coupled with the center of the knuckle.

Moreover, trailing aim suspensions are well known and commonly used in heavy-duty vehicles, such as semi tractor-trailer configurations, as well as off-road vehicles such as four-wheeled buggies. A typical trailing arm suspension comprises a trailing aim having one end pivotally connected to a vehicle frame through a frame bracket and another end connected to the vehicle frame by a spring or strut. The trailing arm supports an axle to which the vehicle wheels are mounted. Road-induced reaction forces acting on the wheels are controlled by the pivoting of the trailing arm in response to these forces, with the forces being resisted by the spring.

Given that off-road vehicles routinely travel over very rough terrain, such as mountainous regions, there is a desire to improve the mechanical strength and performance of off-road suspension systems, while at the same reducing the mechanical complexity of such suspension systems.

### SUMMARY

An apparatus is provided for a fastener for off-road vehicle suspension systems. The fastener comprises a flanged bolt that includes a shank with a threaded portion at one end. A washer flange and a head are disposed at an end of the shank opposite of the threaded portion. The washer flange and the head comprise a single component. A flanged nut threadably engages with the threaded portion and includes a hex head and a washer flange. In an assembled state of the fastener, the flanged nut is fully engaged with the threaded portion, such that the shank extends between a finished surface comprising the flanged nut and a finished surface comprising the washer flange. The assembled state includes the finished surface of the flanged nut being parallel with the finished surface of the washer flange, such that a grip distance is disposed between the parallel finished surfaces.

In an exemplary embodiment, a fastener for off-road vehicle suspension systems comprises: a flanged bolt including a shank with a threaded portion at one end; a washer flange and a head disposed at an end of the shank opposite of the threaded portion; and a flanged nut configured to threadably engage with the threaded portion and including a hex head and a washer flange.

In another exemplary embodiment, the fastener further comprises a radius that joins a finished surface of the washer flange with the shank, the finished surface being configured to forcibly contact metallic and non-metallic components of a vehicle chassis. In another exemplary embodiment, the shank has a diameter suitable for hingedly coupling an off-road vehicle trailing arm to a chassis of the off-road vehicle.

In another exemplary embodiment, a runout comprises a transition between the shank and the threaded portion. In another exemplary embodiment, the runout comprises a rounded portion of the shank that transitions to the threaded portion. In another exemplary embodiment, the runout includes a beveled portion of the shank adjacent to the threaded portion.

In another exemplary embodiment, the washer flange and the head comprise a single component. In another exemplary embodiment, the head includes a hexagon shape suitable for being engaged with a tool, whereby the flanged bolt may be rotated. In another exemplary embodiment, the hex head and the washer flange comprise a single component; and wherein the washer flange includes a finished surface that is configured to forcibly contact metallic and non-metallic components of a vehicle chassis. In another exemplary embodiment, the hex head includes a hexagon shape suitable for being engaged with a tool, whereby the flanged nut may be rotated.

In another exemplary embodiment, the flanged nut includes a central hole extending through the nut and configured to receives the threaded portion of the flanged bolt. In another exemplary embodiment, the central hole includes a smooth portion comprising a diameter sufficient to allow a portion of the shank to extend into the central hole. In another exemplary embodiment, one or more threads are disposed along the side walls of the central hole and are shaped and sized to threadably receive the threaded portion.

In another exemplary embodiment, a runout is disposed between the one or more threads and the smooth portion. In another exemplary embodiment, the runout is configured to prevent the shank from extending too far into the central hole and damaging the one or more threads. In another exemplary embodiment, the runout comprises a bevel that extends from the smooth portion to the one or more threads. In another exemplary embodiment, the runout comprises a rounded surface extending from the smooth portion to the one or more threads.

In another exemplary embodiment, an assembled state of the fastener comprises the flanged nut being fully engaged with the threaded portion, such that the threaded portion is fully received into a central hole extending through the flanged nut and the shank extends between a finished surface comprising the flanged nut and a finished surface comprising the washer flange. In another exemplary embodiment, the assembled state includes the finished surface of the flanged nut being parallel with the finished surface of the washer flange, a grip distance being disposed between the finished surface of the flanged nut and the finished surface of the washer flange. In another exemplary embodiment, the grip distance comprises an exposed portion of the shank between the finished surface of the flanged nut and the finished surface of the washer flange.

### BRIEF DESCRIPTION OF THE DRAWINGS

The drawings refer to embodiments of the present disclosure in which:

FIG. 1 illustrates an exemplary embodiment of a fastener for off-road vehicle suspension systems, according to the present disclosure; and

FIG. 2 illustrates the fastener of FIG. 1 in an assembled state, in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first trailing arm,” may be made. However, the specific numeric reference should not be interpreted as a literal sequential order but rather interpreted that the “first trailing arm” is different than a “second trailing ann.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Off-road vehicles routinely travel over very rough terrain, such as mountainous regions. As such, there is a desire to improve the mechanical strength and performance of off-road suspension systems, while at the same reducing the mechanical complexity of such suspension systems. Embodiments of the present disclosure provide a fastener for off-road vehicle suspension systems.

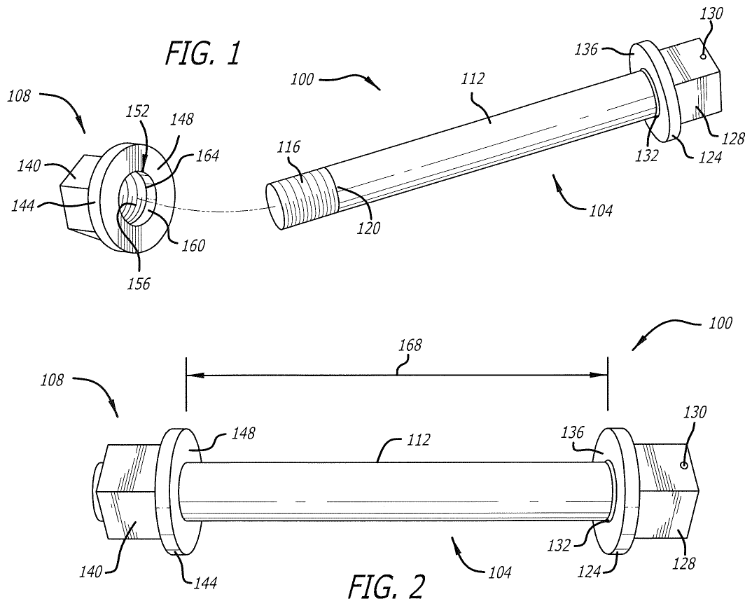

FIG. 1 illustrates an exemplary embodiment of a fastener 100 configured for off-road vehicle suspension systems, according to the present disclosure. In general, the fastener 100 includes a flanged bolt 104 and flanged nut 108 combination. The flanged bolt 104 includes a smooth shank 112 having a diameter suitable for hingedly coupling an off-road vehicle trailing arm to a chassis of the off-road vehicle. The flanged bolt 104 is not limited to being used with vehicle trailing arms, however. Rather, it is contemplated that the flanged bolt 104 may be used in combination with a wide variety of components comprising vehicle suspension systems, such as, by way of non-limiting example, steering tie rods, upper and lower suspension arms, spindle assemblies, steering rod-end joints, struts, various chassis mounting points, and the like, without limitation.

As shown in FIG. 1, the flanged bolt 104 includes a threaded portion 116 disposed at one end of the shank 112. The threaded portion 116 is configured to threadably engage with the flanged nut 108. A runout 120 comprises a transition between the shank 112 and the threaded portion 116. It is contemplated that, in some embodiments, the runout 120 may be comprise a rounded portion of the shank 112 that transitions to the threaded portion 116. In some embodiments, the runout 120 includes a beveled portion of the shank 112 adjacent to the threaded portion 116.

With continuing reference to FIG. 1, the flanged bolt 104 includes a washer flange 124 and a head 128 disposed at an end of the shank 112 opposite of the threaded portion 116. As will be recognized, the washer flange 124 and the head 128 comprise a single component, thereby obviating any need for a practitioner having to supply a separate washer. In the illustrated embodiment, the head 128 includes a hexagon shape suitable for being engaged with a tool, such as a socket wrench, whereby the flanged bolt 104 may be rotated. It is contemplated, however, that any of various suitable shapes may be incorporated into the head 128, without limitation. Further, any of various holes 130, notches, or other desirable structures may be included in the head 128, whereby the flanged bolt 104 may be secured by way of a lock pin or other hardware.

As shown in FIG. 1, a radius 132 joins a finished surface 136 of the washer flange 124 with the shank 112. As will be appreciated, the finished surface 136 generally is configured to contact smooth surfaces comprising components to which the flanged bolt 104 may be fastened. For example, when the fastener 100 hingedly couples a trailing min with a vehicle chassis, the finished surface 136 forcibly contacts flat surfaces comprising the chassis. In some embodiments, however, the finished surface 136 may contact non-metallic components, such as, by way of non-limiting example, rubber bushings and the like, without limitation.

With continuing reference to FIG. 1, the flanged nut 108 includes hex nut 140 and a washer flange 144. The hex head 140 and the washer flange 144 comprise a single component, which obviates the need for the practitioner having to provide a separate washer. Preferably, the washer flange 144 is substantially similar to the washer flange 124 discussed hereinabove. As such, the washer flange 144 includes a finished surface 148 that is configured to forcibly contact metallic and non-metallic components to which the fastener 100 is coupled. Further, the hex head 140 includes a hexagon shape suitable for being engaged with a tool, such as a socket wrench, whereby the flanged nut 108 may be rotated. It is contemplated, however, that the head 140 may include any of various suitable shapes for being engaged with different tools, without limitation.

As shown in FIG. 1, the flanged nut 108 includes a central hole 152 extending through the nut and configured to receives the threaded portion 116 of the flanged bolt 104. One or more threads 156 are disposed along the side walls of the central hole 152. As will be recognized, the threads 156 are shaped and sized so as to threadably receive the threaded portion 116 during assembly of the flanged nut 108 onto the flanged bolt 104. Further, the central hole 152 includes a smooth portion 160 adjacent to the finished surface 148. The smooth portion 160 preferably comprises a diameter sufficient to allow a portion of the shank 112 to extend into the central hole 152 during maximal engagement of the flanged nut 108 and the flanged bolt 104.

As best shown in FIG. 2, allowing the shank 112 to enter into flanged nut 108 ensures that the threaded portion 116 is disposed entirely within the central hole 152 once the flanged nut 108 is desirably assembled with the flanged bolt 104. Further, as shown in FIG. 1, a runout 164 is disposed between the threads 156 and the smooth portion 160. It is contemplated that the runout 164 may be configured to contact the runout 120 so as to prevent the shank 112 from extending too far into the central hole 152 and damaging the threads 156. In the illustrated embodiment, the runout 164 comprises a bevel that extends from the smooth portion 160 to the threads 156. In some embodiments, however, the runout 164 may be comprised of a rounded surface extending from the smooth portion 160 to the threads 156. It should be understood, therefore, that the runout 164 may include any of various shapes or angled bevels, as desired, and without limitation.

FIG. 2 illustrates the fastener 100 in an assembled state, wherein the flanged nut 108 is fully engaged with the threaded portion 116 of the flanged bolt 104. In the assembled state shown in FIG. 2, the finished surface 148 of the flanged nut 108 preferably is disposed parallel with the finished surface 136 of the flanged bolt 104, and the threaded portion 116 is fully received into the central hole 152 with the shank 112 extending between the washer flanges 124, 144. As will be recognized, the assembled state of the fastener 100 shown in FIG. 2 is advantageously suited for hingedly mounting a trailing arm of a vehicle suspension system to a chassis of the vehicle. With the threaded portion 116 fully engaged within the central hole 152 and the shank 112 extending between the washer flanges 124, 144, friction between the fastener 100 and the trailing arm is minimized.

As shown in FIG. 2, when the flanged nut 108 is fully engaged with the threaded portion 116, a grip distance 168 is disposed along the exposed portion of the shank 112 between the washer flanges 124, 144. As will be appreciated, the fastener 100 may be manufactured such that the grip distance 168 has a specific, desired value. In general, the specific value of the grip distance 168, as well as the diameter and length of the shank 112, depends upon the application with which the fastener 100 is intended to be used. For example, when configured for coupling a trailing arm to the chassis of the vehicle, the fastener 100 generally will be larger in diameter and longer than when the fastener 100 is configured to couple a control arm to the vehicle. Further, it should be understood that the fastener 100 may be comprised of various suitable metals, such as various grades of steel and aluminum alloys, depending on the intended application, without limitation.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A fastener for off-road vehicle suspension systems, the fastener comprising:
a flanged bolt including a shank with a threaded portion at one end;
a washer flange and a head disposed at an end of the shank opposite of the threaded portion; and
a flanged nut configured to threadably engage with the threaded portion and including a hex head and a washer flange.

2. The fastener of claim 1, further comprising a radius that joins a finished surface of the washer flange with the shank, the finished surface being configured to forcibly contact metallic and non-metallic components of a vehicle chassis.

3. The fastener of claim 1, wherein the shank has a diameter suitable for hingedly coupling an off-road vehicle trailing aim to a chassis of the off-road vehicle.

4. The fastener of claim 1, wherein a runout comprises a transition between the shank and the threaded portion.

5. The fastener of claim 4, wherein the runout comprises a rounded portion of the shank that transitions to the threaded portion.

6. The fastener of claim 4, wherein the runout includes a beveled portion of the shank adjacent to the threaded portion.

7. The fastener of claim 1, wherein the washer flange and the head comprise a single component.

8. The fastener of claim 1, wherein the head includes a hexagon shape suitable for being engaged with a tool, whereby the flanged bolt may be rotated.

9. The fastener of claim 1, wherein the hex head and the washer flange comprise a single component; and wherein the washer flange includes a finished surface that is configured to forcibly contact metallic and non-metallic components of a vehicle chassis.

10. The fastener of claim 9, wherein the hex head includes a hexagon shape suitable for being engaged with a tool, whereby the flanged nut may be rotated.

11. The fastener of claim 1, wherein the flanged nut includes a central hole extending through the nut and configured to receives the threaded portion of the flanged bolt.

12. The fastener of claim 11, wherein the central hole includes a smooth portion comprising a diameter sufficient to allow a portion of the shank to extend into the central hole.

13. The fastener of claim 12, wherein one or more threads are disposed along the side walls of the central hole and are shaped and sized to threadably receive the threaded portion.

14. The fastener of claim 12, wherein a runout is disposed between the one or more threads and the smooth portion.

15. The fastener of claim 14, wherein the runout is configured to prevent the shank from extending too far into the central hole and damaging the one or more threads.

16. The fastener of claim 15, wherein the runout comprises a bevel that extends from the smooth portion to the one or more threads.

17. The fastener of claim 15, wherein the runout comprises a rounded surface extending from the smooth portion to the one or more threads.

18. The fastener of claim 1, wherein an assembled state of the fastener comprises the flanged nut being fully engaged with the threaded portion, such that the threaded portion is fully received into a central hole extending through the flanged nut and the shank extends between a finished surface comprising the flanged nut and a finished surface comprising the washer flange.

19. The fastener of claim 18, wherein the assembled state includes the finished surface of the flanged nut being parallel with the finished surface of the washer flange, a grip distance being disposed between the finished surface of the flanged nut and the finished surface of the washer flange.

20. The fastener of claim 18, wherein the grip distance comprises an exposed portion of the shank between the finished surface of the flanged nut and the finished surface of the washer flange.
